(19) United States
(12) Patent Application Publication
(10) Pub. No.: US 2020/0413018 A1
(43) Pub. Date: Dec. 31, 2020

(54) GENERATING A COLOR MAPPING

(71) Applicant: HEWLETT-PACKARD DEVELOPMENT COMPANY, L.P., Spring, TX (US)

(72) Inventors: Jordi VILAR, Sant Cugat del Valles (ES); Juan Miguel HUERTAS DELGADO, Sant Cugat del Valles (ES); Jan MOROVIC, London (GB); Jordi ARNABAT BENEDICTO, Sant Cugat del Valles (ES)

(73) Assignee: HEWLETT-PACKARD DEVELOPMENT COMPANY, L.P., Spring, TX (US)

(21) Appl. No.: 16/977,707

(22) PCT Filed: Mar. 12, 2018
(86) PCT No.: PCT/US2018/022037

§ 371 Date: Sep. 2, 2020

(51) Int. Cl. H04N 9/67

(52) U.S. Cl. CPC H04N 9/67

(57) ABSTRACT

Certain examples described herein relate to generating a color mapping between a source color gamut within a source color space and a target color gamut within a target color space. Gamuts may be set based on a color rendering device. In examples, a sequence of forward color transformations that transform the source color gamut is defined, along with a sequence of inverse color transformations that transform the target color gamut. A gamut mapping is applied between the output of the forward color transformations and the output of the inverse color transformations, wherein the color mapping is usable by a computing device to map between the source and target color spaces.

### BACKGROUND

Different technical devices handle and render color representations in different ways. For example, a printing device may be configured to deposit discrete amounts of a set of colorants such as Cyan, Magenta, Yellow and Black. Similarly, a display device may electrically modulate liquid crystal elements that have Red, Green and Blue filters. For this reason, color management technologies have been developed that map color representations between different devices. Color management may involve defining a device-dependent color space based on configurable states of an associated rendering device. For example, a device-dependent color space for a display device may have three dimensions representing different values of Red, Green and Blue color channels (e.g. an 8 bit RGB image may have three 8 bit channels, where each channel has a range of integer values between 0 and 255). Certain color management technologies provide for mappings to device-independent color spaces, such as profile connection spaces, as an intermediate operation in a device-to-device color mapping. When color management is applied there is an issue of how to provide color adjustments, as color mapping may distort a rendered color and/or lead to unpredictable output.

### BRIEF DESCRIPTION OF THE DRAWINGS

Various features of the present disclosure will be apparent from the detailed description which follows, taken in conjunction with the accompanying drawings, which together illustrate, features of certain examples, and wherein:

FIG. 1 is a schematic illustration of an apparatus for generating color mapping data according to an example;

FIG. 2 is a schematic illustration showing a color mapping pipeline according to an example;

FIG. 3 is a flow diagram showing production of a color profile according to an example;

FIG. 4 is a flow diagram showing a method of generating a color mapping according to an example;

FIG. 5 is a schematic diagram of a non-transitory computer-readable storage medium according to an example; and

FIGS. 6A and 6B are schematic illustrations of a gamut mapping according to an example.

### DETAILED DESCRIPTION

Certain examples described herein address a challenge of how to provide color adjustments in a color management system. Certain examples described herein present a method and apparatus for mapping between color gamuts that improve an effectiveness of color transformations applied to color data.

Certain examples described herein relate to gamut mapping. A gamut is a volume in a multi-dimensional color space. A gamut represents a range of renderable colors for a rendering device. The multi-dimensional color space may be device-dependent, e.g. have dimensions that are set by the physical properties and/or characteristics of a particular rendering device, or may be device-independent, e.g. be independent of any one rendering device. Red, Green, Blue (RGB) color spaces are typically device-dependent and have three dimensions or channels, each representing an intensity of one of the three colors; similarly, a Cyan, Magenta, Yellow and Black (CMYK) color space is a device-dependent color space that is dependent on a number of colorants used in a printing system. Examples of device-independent color spaces include those defined by the Commission Internationale de l'Eclairage (CIE) such as CIEXYZ and CIEL*a*b* color spaces. Hence, a particular rendering device may have a particular color gamut in a particular color space, e.g. a monitor may have a three-dimensional volume in RGB color space representing all the colors that may be displayed by the monitor (i.e. data points that can be rendered).

When moving between rendering devices, defined colors are mapped between color spaces. For example, a color image may be shown to a user of a design application via a computer monitor and be stored as pixel values in an RGB color space. The user may then wish to print the image on a printing device. The printing device may have four colorants—CMYK—and thus represent colors in a CMYK color space. In this case, the color image in the RGB color space needs to be converted to a print image in CMYK color space. Hence, data points defined within a given range of three dimensions are to be converted into a given (and typically different) range in four dimensions. Moreover, the set of colors that are renderable on the computer monitor (e.g. that can be displayed) may differ from the set of colors that are renderable by the printing device (e.g. that can be printed). In this case, a color gamut for the computer monitor in RGB color space is to be mapped to a color gamut for the printing device in CMYK color space. For example, a naive linear mapping may result in initial color points that are outside the gamut of the printing device. Gamut mapping adjusts these color points so that they are reproduced within the color gamut of the printing device.

To provide flexibility, many computing devices provide color mapping by mapping to an intermediate device-independent color space. Device-independent color spaces tend to be based on standardized color representations. As such, color representations for different devices may be mapped to a common well-defined color space. In a computing device, a color profile may be provided to map between the device-dependent color space and the device-independent color space. For example, the International Color Consortium (ICC) provides a standardized specification for color mapping between a source and/or target device-dependent color space and a profile connection space, a standardized device-independent color space. This specification sets out the configuration of a file called an ICC color profile that is used to perform the mapping. Similarly, a device link profile may be provided to map between two device-dependent color spaces, typically by way of a hidden intermediate device-independent color space color mapping.

When performing color mapping, it may be desired to change certain color properties. For example, it may be desired to modify hue, chroma and/or lightness characteristics. These modifications may be provided by way of one or more color transformations. In comparative cases, when rendering colors, these color transformations are applied in a device-independent color space before gamut mapping occurs, or in a device-dependent color space after gamut mapping occurs. Hence, the color transformations are applied in a single, uni-directional sequence. If the color transformations are applied before gamut mapping this may lead to unpredictability, as gamut mapping typically applies irreversible, non-linear transformations. If color transformations are applied after mapping, e.g. to a device gamut, they may have a constrained impact.

Certain examples described herein involve defining sequences of color transformations that modify the gamuts that form the fixed points of gamut mapping. In particular, a device-dependent color gamut, e.g. as measured based on an output of a rendering device, is transformed by a series of inverse color transformations that are applied backwards from a measured color gamut to change the output gamut that is mapped to in the gamut mapping process. This differs from comparative approaches where the output of the gamut mapping process is fixed as the measured color gamut and color transformations are applied to the measured color gamut of the device in a forward direction following the gamut mapping.

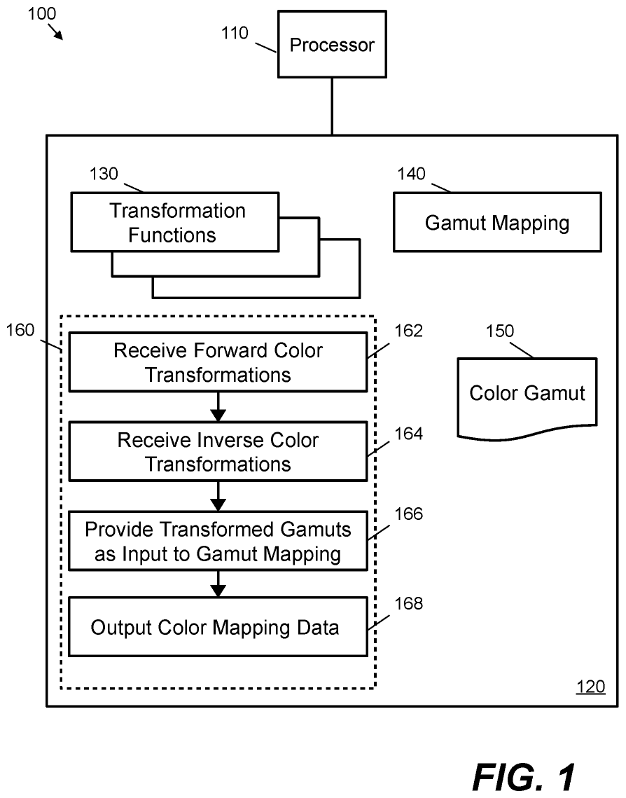

FIG. 1 shows an example apparatus 100 for generating color mapping data. The apparatus comprises a processor 110 and a storage medium 120. Although the storage medium 120 is shown as a single medium, in practice it may be implemented by several different mediums, such as different storage devices or memories. The processor 110 is arranged to, in use, control the operation of the apparatus to generate data that is usable to map colors. This data may comprise a color profile or device link profile. The processor 110 may include at least one central processing unit, at least one semiconductor-based microprocessor, other hardware devices or processing elements suitable to retrieve and execute instructions stored in memory, or combinations thereof. In one case, the processor 110 may comprise part of control circuitry including an Application Specific Integrated Circuit (ASIC) or a Field Programmable Gate Array (FPGA). The processor can include single or multiple cores on a chip, multiple cores across multiple chips, multiple cores across multiple devices, or combinations thereat. The processor may fetch, decode, and execute instructions from a memory to perform various functions. Instructions may be loaded into memory from the storage medium 120 or the memory may comprise the storage medium 120. As an alternative or in addition to retrieving and executing instructions, the processor may include at least one integrated circuit (IC), other control logic, other electronic circuits, or combinations thereof that include a number of electronic components for performing various tasks or functions as described herein. In one case, the storage medium 120 may comprise a volatile or non-volatile memory or register accessible to the processor 110. The storage medium 120 may comprise, for example, various RAM, ROM, flash memory, and combinations thereof. For example, the machine-readable medium may include a Non-Volatile Random-Access Memory (NVRAM), an Electrically Erasable Programmable Read-Only Memory (EEPROM), a storage drive, a NAND flash memory, and the like. The storage medium may alternative comprise solid state or magnetic storage or the like. The apparatus 100 may form part of a color management system, such as a server computing device that generates color mapping data for particular rendering devices or part of the rendering device itself.

The storage medium 120 in FIG. 1 stores computer program code for execution, in use, by the processor 110. This includes computer program code 130 representing a library of color transformation functions. In this example, each color transformation function has a set of parameters and operates on input color data to generate output color data. An instance of a color transformation function may comprise a color transformation function with defined parameters and input/output specifications, such as dimensions, data types and/or range constraints. As examples, a color transformation function may apply: modifications to hue, e.g. to modify colorfulness or purity of an image; modifications to chroma, e.g. to create vivid prints with greater impact; and modifications to lightness, e.g. to control contrast and detail. Parameters for a color transformation function may indicate how an instance of a color transformation is to be applied, e.g. comprise a specification of a curve for tone or saturation adjustments. A specific input and output configuration may be defined for an instance of a color transformation function, e.g. a dimensionality and range of allowable values may be defined.

The storage medium 120 also stores computer program code 140 representing a gamut mapping function. The gamut mapping function maps a source color gamut to a target color gamut. Like instances of a color transformation function, an instance of the gamut mapping function may define a particular mapping between data points of a first dimensionality and range to data points of a second dimensionality and range. The gamut mapping function may represent a geometric transform that maps the volume associated with the source color gamut to the volume associated with the target color gamut. The geometric transform may not be continuous and/or may not be linear. The gamut mapping function may apply one or more of clipping and compression of data values to provide the mapping. The gamut mapping function may take the form of a mathematically defined function, as expressed in computer program code for execution by the processor 110, and/or a set of input and output data points, which may be represented in a look-up table. In the latter case, mappings outside of the defined data points may be made using interpolation.

The storage medium 120 also stores data 150 defining a color gamut for a rendering device. The color gamut is set based on properties of the rendering device. The color gamut may be defined by sampling from a device-dependent color space. In one case, it may be determined whether sampled points can be successfully rendered. In another case, measurements may be made of a rendered output and a volume fitted to the data points. In another case, a list of data points that violate operating constraints may be made. A variety of approaches are possible.

Lastly, the storage medium 120 stores computer program code 160 that when executed causes the processor 110 to perform a number of operations. Via instructions 162, the processor 110 is instructed to receive a sequence of forward color transformations. The forward color transformations are selected from the library of color transformation functions, e.g. they may comprise particular instances of a color transformation function. The sequence of forward color transformations acts to transform a source color gamut defined within a source color space. The sequence of forward color transformations is arranged such that the output of a first forward color transformation is used as the input of a subsequent forward color transformation, e.g. for consecutive pairs of forward color transformations in the sequence. The instructions 162 may comprise configuring defined inputs and outputs of the forward color transformations such that they meet the constraints of the sequence; for example, if a forward color transformation reduces a range of one or more dimensions in a color space, then the next forward color transformation in the sequence may be configured to receive input within that range. Similarly, if a forward color transformation adds, removes or constrains a dimension, this is taken into account for the input of the next forward color transformation. The received sequence of forward color transformations modifies the source color gamut, e.g. geometrically modifies the volume within multi-dimensional space, to output, at the end of the sequence, a modified source color gamut.

Via instructions 164, a sequence of inverse color transformations is also received. The inverse color transformations are also selected from the library of color transformation functions as described for instructions 162. The sequence of inverse color transformations is to be applied to transform a target color gamut defined within a target color space. In this case, the output of the sequence is constrained to be the target color gamut and the inverse color transformations are constrained to generate this final output. For example, if the last inverse color transformation comprises a contrast transformation, a color gamut output following that transformation is constrained to be the target color gamut, and a color gamut at the input is modified to accommodate the contrast transformation. Similarly, if a chroma transformation is applied as the penultimate inverse color transformation, then a color gamut at its output is constrained to match the color gamut at the input of the contrast transformation, and a color gamut at the input of the chroma transformation is modified based on the chroma transformation. As such the sequence of inverse color transformations are applied backwards starting from the target color gamut as a fixed set of data points, where the output of the color transformations is constrained and the color transformations applied to modify input data points (i.e. apply inverse transformations).

Via instructions 166, the processor 110 is instructed to provide the transformed source color gamut and the transformed target color gamut as inputs to the gamut mapping function. For example, a comparative implementation of the gamut mapping function may operate to map from the source color gamut to the target color gamut, wherein color transformations are applied before, or after, the gamut mapping. In the present case, the color transformations are folded into, or moved inside of, the gamut mapping operation. This is achieved by setting the transformed source color gamut and the transformed target color gamut as the respective input and output volumes for the gamut mapping function. The transformed source color gamut comprises the result of applying the sequence of forward color transformations to the source color gamut. The transformed target color gamut comprises the result of applying the sequence of inverse color transformations with a final output constrained as the target color gamut.

Via instructions 168, the processor 110 is instructed to output color mapping data generated based on the received sequences and the gamut mapping function that maps color data from the source color space to the target color space. This may comprise applying the received sequences and the gamut mapping function in the defined orders to data point samples. For example, the received sequences and the gamut mapping function may be applied to a series of data points from within the source color gamut and/or the target color gamut. For example, the gamut mapping function may clip colors in an input color gamut that lie outside of an output color gamut, where clipping may comprise setting a data point to a value that lies on a gamut boundary for the output color gamut. In the present example, the gamut mapping function operates on the transformed source color gamut as input and the transformed target color gamut as output. Hence, clipping clips values that are within the transformed source color gamut to a boundary of the transformed target color gamut, e.g. rather than the target color gamut itself. Similarly, if compression is performed, e.g. applied to in-gamut data points, this is performed relative to ranges in the transformed color gamuts as opposed to the original source and target color gamuts.

In the example of FIG. 1, one of the source color gamut and the target color gamut comprises the color gamut for the rendering device. As such, the apparatus 100 of FIG. 1, provides a way to map to or from a device dependent color space as constrained by the nature of the rendering device.

In certain cases, the color mapping data comprises one of a color profile and a device-link profile to map color data for rendering on the rendering device. A color profile may be used by a computing device to convert color data (e.g. for an image) from a device-independent color space to the device-dependent color space for the rendering device such that following the mapping the color data points lies within a renderable volume. These profiles may be structured according to the ICC standard, or may be structured according to other formats, including proprietary formats.

In certain cases, the color mapping data is generated in the form of a look-up table by sampling data points in at least one of the source and target color spaces and applying the received sequences and the gamut mapping function to the sampled data points. For example, the received sequences and the gamut mapping function may be considered a single transformation from the source color space to the target color space. Sampling the application of this single transformation to input data points may be used to populate a multidimensional look-up table. This allows the overall transformation to be converted into a resource that may be embedded in a color profile, such as an ICC color profile.

The rendering device may comprise a variety of devices. In one case, the rendering device comprises a two or three dimensional printer. In other cases, the rendering device comprises a display device such as a monitor or television screen. If the target color space comprises the device-dependent color space for the rendering device, the target color space may comprise one of a Red Green Blue (RGB) based color space and a Cyan Magenta Yellow and Black (CMYK) based color space. Other color spaces are possible.

As described above, the sequence of inverse color transformations is applied starting from the target color space, wherein an output of a first inverse color transformation applied to a data point in the target color space is passed to an input of a second inverse color transformation for ordered pairs of first and second inverse color transformations in the sequence of inverse color transformations.

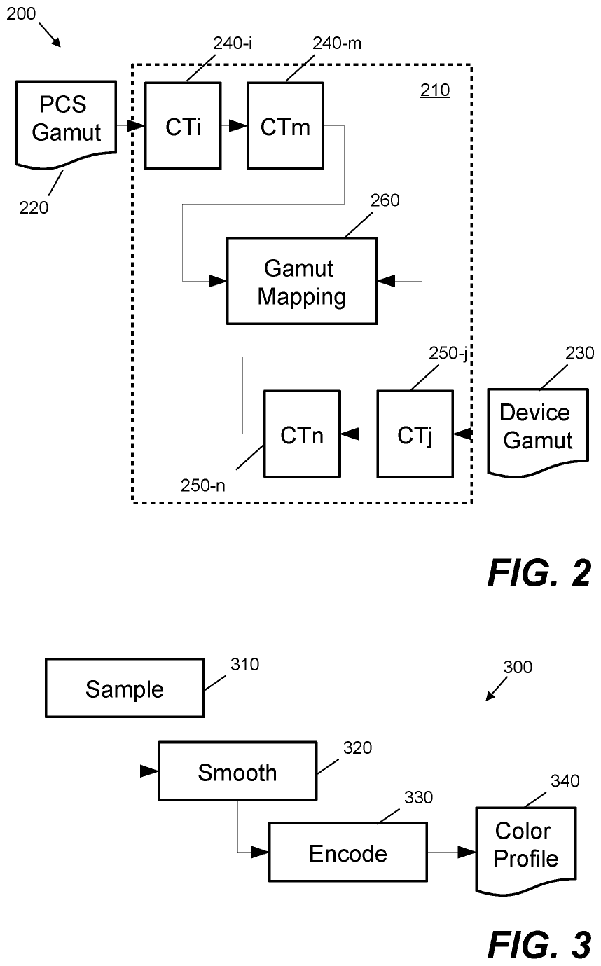

FIG. 2 is a schematic diagram that illustrates an application 200 of described examples. Dotted box 210 represents an extent of a comparative gamut mapping operation that maps a source color gamut 220 to a target color gamut 230. In this application 200, the source color gamut 220 is in profile connection space and the target color gamut 230 comprises a device gamut as defined in a device dependent space. For example, the device gamut may relate to a CMYK printer and thus be defined in a four dimensional CMYK color space. As illustrated by dotted box 210, a comparative gamut mapping takes the source color gamut 220 and maps it to the device color gamut 230. This is performed so that colors may be rendered on the device, e.g. printed on the printer. In the comparative case, the process flow is unidirectional, e.g. from source color gamut 220 into the gamut mapping 210 and from the gamut mapping to the target color gamut 230. The present example differs from the comparative case as a series of color transformations are defined to modify the source and target color gamuts, i.e. there is a reversed directionality of color transformation from the target color gamut 230 as indicated by the direction of the arrows in the Figure.

In FIG. 2, a plurality of forward color transformations 240 are shown that transform the source color gamut 220. Similarly, a plurality of inverse color transformations 250 are also shown that transform the target color gamut 230. The arrows in the Figure indicate a direction in which the color transformations are applied. There may be m forward color transformations 240 and n inverse color transformations 250. An output of forward color transformation i is provided as input to forward color transformation i+1; similarly, an output of inverse color transformation j is provided as input to inverse color transformation j+1, where the output of forward color transformation m and the output of inverse color transformation n respectively define the gamuts that are mapped by a gamut mapping process 260. The forward color transformations 240 and inverse color transformations 250 thus precede the final gamut mapping process 260. Furthermore, the order and location of the color transformations matter: the input space of a color transformation is the output space of the preceding color transformation. Hence, features of color data passing through the color transformations also change as the sequences are applied. The features include the gamut itself, black point, color primary definitions, and the like.

The gamut mapping process 260 maps colors from one sequence of color transformations to colors in the other sequence of color transformations. This mapping may involve clipping colors in the input gamut that lie out of the output gamut. It may also involve color compression, and in-gamut color adjustment. The gamut mapping process 260 is applied between the source color space after being transformed by the first sequence of forward color transformations 240, and maps to the destination space (and gamut) after it is transformed by the second sequence of inverse color transformations 250.

FIG. 3 shows an example 300 of an additional number of processes that may be performed following the definition of a color mapping as shown in FIG. 2. At block 310, a sampling operation is applied. Sampling is applied to the end-to-end transformation between the source color gamut 220 and the target color gamut 230 incorporating the forward color transformations 240, the inverse color transformations 250 and the gamut mapping process 260. Sampling may be used to populate a look-up table representing the complete transformation. Sampling may comprise sampling points within a source color space, e.g. that are distributed within this space, and storing a result of the complete transform as applied to each sampled point. At block 320, smoothing may be applied to the look-up table. This may act to filter out artifacts due to factors such as limited measurement accuracy and uneven variation in color transformations. In certain cases, smoothing the look-up table may improve overall image quality. At block 330, an encoding operation is applied. This may embed the look-up table in an ICC color profile 340. The ICC color profile 340 is then usable by a color management system to convert color data to a device-dependent color space. At block 330, encoding may comprise configuring the data resulting from block 320 to comply with a predefined standard and/or format. In the case of an ICC profile, encoding at block 330 may comprise creating dedicated ‘tags’ (i.e. a labeled chunk of structured data) that includes different information, for instance, the dimensions of the input and output spaces, pre- and post-linearization curves, a 3×3 matrix, a multidimensional look-up table and the like, where this data is formatted according an encoding specification that forms part of an ICC standard. This may involve ensuring that constraints such as a number of bits used for data value and a range of valid values and the like are met.

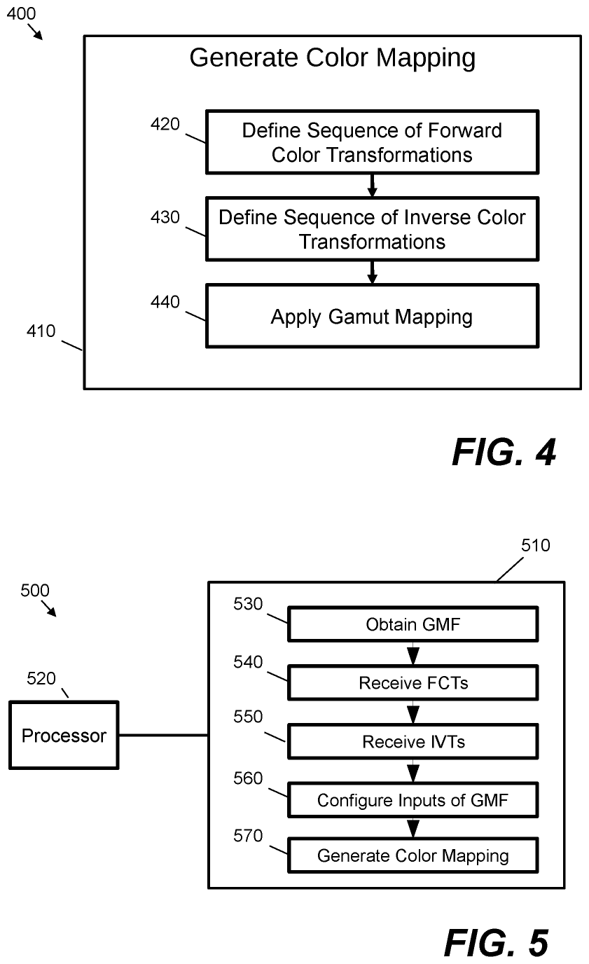

FIG. 4 shows an example method 400 comprising a block 410 of generating a color mapping between a source color gamut within a source color space and a target color gamut within a target color space. In this example, at least one of the source and target color spaces comprises a device-dependent color space and at least one of the source and target color gamuts is set based on properties of a rendering device, i.e. is a device gamut in a device-dependent color space. In the example of FIG. 4, block 410 comprises three specific subblocks. These differentiate the method from comparative approaches. At subblock 420, a sequence of forward color transformations is defined that transform the source color gamut. These may be forward color transformations 240 as described above. At subblock 430, a sequence of inverse color transformations that transform the target color gamut are also defined. These may be inverse color transformations 250 as described above. “Defining” each sequence of color transformations may comprise determining an order of application and parameters for each color transformation. Once the order of application is defined then inputs and outputs can be appropriately coupled within the sequence. “Defining” in certain cases may comprise writing computer program code, e.g. in the form of a script or the like, and/or making selections via a user interface, e.g. selecting the use of color transformations from a library of color transformations 130 as shown in FIG. 1.

At subblock 430, a gamut mapping is applied between the output of the forward color transformations and the output of the inverse color transformations. Hence, the color mapping of block 410 comprises the application of the sequence of forward color transformations, the sequence of reverse color transformations and the gamut mapping, i.e. the end-to-end process shown in FIG. 2. The color mapping generated by block 410 is usable by a computing device to map between the source and target color spaces, e.g. to convert from a device-dependent color space to a device-independent color space or vice versa.

The method of FIG. 4 may further comprise generating a multidimensional look-up table representative of the mapping and encoding the multidimensional look-up table in a color profile for use by a computing device to map the first color space to the second color space. For example, the method of FIG. 4 may apply processes similar to those shown in FIG. 3, including one or more of sampling, smoothing and encoding.

The nature of the source and target color spaces may depend on the implementation. In a first case, the first color space comprises a device-independent color space, such as a profile connection space, and the second color space comprises the device-dependent color space. In this case, the color mapping may generate a color profile for mapping received color data to a standardized color space. The second color space may comprise a color space for a rendering device, and the color mapping data may be useable by a computing device to process color image data for rendering on the rendering device. In a second case, the first color space comprises the device-dependent color space and the second color space comprises a device-independent color space. In this case, the color mapping may generate a color profile for rendering color data received from a standardized color space. In a third case, the first color space comprises a device-dependent color space for a first device and the second color space comprises a device-dependent color space for a second device. In this case, the color mapping may generate a device link profile for mapping between color representations used by two devices (e.g. between different types of display device, or between a display device and a printing device).

The sequence of forward color transformations comprises an ordered sequence of a plurality of color transformations. These may be selected from the set of: adjusting the first color space based on a reference media; adjusting the first color space based on a defined tone curve; adjusting the chroma characteristics of the first color space; adjusting the saturation characteristics of the first color space; and applying black point compensation.

An example set of forward color transformations will now be described, working from a profile connection space. These are provided to illustrate how the present examples may be used in a printing context and should not be seen as limiting, they are just one possible sequence out of many possible sequences of varying lengths and orders. In this example, a first forward color transformation may comprise a primary adjustment. This morphs a color gamut defined in profile connection space to take into account a reference media gamut. It may also involve adjusting the primaries of the reference media gamut with primaries of a rendering device gamut, e.g. for a printing device. The primary adjustment may finish by expanding a given transformation to a remaining portion of the profile connection space. A second forward color transformation may comprise applying an adjustment based on a tone curve. This adjustment is made to points in color space that have already been modified by the primary adjustment. The adjustment based on the tone curve may comprise adjusting points in a color space with reference to a tone curve that will compress or expand the space in a L* axis. A third forward color transformation may comprise chroma or saturation adjustment. This may be applied to the color points following the tone curve adjustment. This adjustment may comprise modifying the chroma and/or saturation conditions of the color space by applying a radial color transformation. Lastly, in this example, black point compensation may be applied. This is best applied as a later stage and involves expansion and/or compression of an L* axis, such that the black point of the transformed source color gamut best matches the black point of the transformed target color gamut.

In a case where the second color space is associated with a rendering device, the sequence of inverse color transformations may comprise an ordered sequence of a plurality of color transformations selected from the set of: applying a correction for gray axis mapping; constraining the dimensionality of the second color space; and adjusting a modeling of a device response for the rendering device.

Following on from the previous example of a set of forward color transformations, an example set of inverse color transformations will now be discussed. Again, these are provided to illustrate how the present examples may be used in a printing context and should not be seen as limiting, they are just one possible sequence out of many possible sequences of varying lengths and orders. Starting from a device color gamut, e.g. as color transformation 250-1 in FIG. 2, a first inverse color transformation may apply a correction for gray axis mapping. For example, certain printing devices have a bespoke design for a native gray axis. This may be mapped to a colorimetric gray axis. A second inverse color transformation may comprise constraining the dimensionality of the second color space if the device-dependent color space has more than four dimensions, e.g. is a CMYK subtractive color space. This inverse color transformation creates constraints between the color space dimensions so it may be effectively transformed as a three-dimensional color space. This may be beneficial when the source color gamut is in a tristimulus color space. For a CMYK color space, this may comprise adding a constraint between the K dimension and the other three dimensions (CMY). The second inverse color transformation may be applied as color transformation 250-2 in FIG. 2. In a printing case, where n=3, a third inverse color transformation may involve adjusting a modeling of a response of the rendering device.

FIG. 5 shows an example 500 of a non-transitory computer-readable storage medium 510 storing instructions that, when executed by a processor 520, cause the processor 520 to perform a series of operations. Via instructions 530, the processor 520 is instructed to obtain a gamut mapping function applicable to a source color gamut defined within a source color space and a target color gamut defined within a target color space. Via instructions 540, the processor 520 is instructed to receive a sequence of forward color transformations selected from a library of color transformation functions that is to be applied to transform the source color gamut. For example, the sequence may be received via a user interacting with a user interface or may be defined in an obtained portion of computer program code. Via instructions 550, the processor 520 is instructed to receive a sequence of inverse color transformations selected from the library of color transformation functions that is to be applied to transform the target color gamut. In this example, one of the source color gamut and the target color gamut comprises a color gamut for a rendering device, the color gamut being set based on properties of the rendering device. Via instructions 560, the processor 520 is instructed to configure an output of the sequence of forward color transformations and an output of the sequence of inverse color transformations as modified inputs to the gamut mapping function. This may comprise defining a pipeline of operations, e.g. in computer program code. Via instructions 570, the processor 520 is instructed to generate color mapping data for mapping from the source color space to the target color space based on an application of both sequences of color transformations and the configured gamut mapping function. This may comprise sampling data points using the defined pipeline of operations. These may comprise executing previously defined computer program code. The source color space may comprise a profile connection space and the target color space may comprise a device color space for the rendering device. In this case, the color mapping data may comprise a color profile for the rendering device.

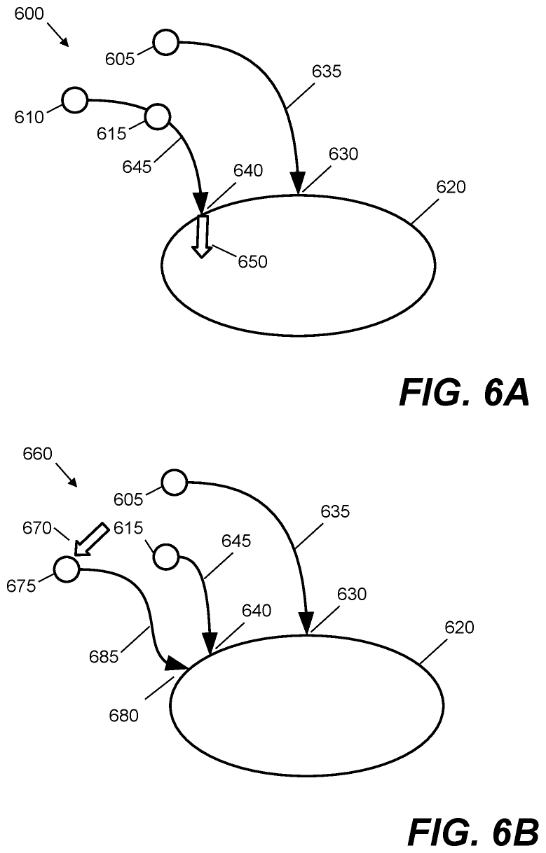

FIGS. 6A and 6B show two examples 600 and 660 of a gamut mapping, and an effect of color transformations applied after or before gamut mapping. The illustrations of FIGS. 6A and 6B are provided to illustrate certain concepts described herein and are not representative of an actual gamut mapping. In both examples, three out-of-gamut colors are shown: 605, 610 and 615. These out-of-gamut colors are mapped to a boundary of a gamut 620 for a device. Hence, colors 605, 610, 615 are initially located at points in a source color space outside the gamut 620 and are then mapped to points in a target color space on or within the gamut 620.

FIG. 6A shows a result of performing a color transformation after gamut mapping. Out-of-gamut color 605 is mapped to color 630, which is on the gamut boundary. The two out-of-gamut colors 610 and 615 are mapped to a common color 640 on the gamut boundary (sometimes referred to as “collapsing” the colors). Arrows 635, 645 illustrate the mapping. Arrow 650 shows how the color 640 is transformed—as such out-of-gamut colors 610 and 615 are transformed in a common manner. FIG. 6B shows the same color transformation 670 performed before gamut mapping. This color transformation shifts out-of-gamut color 610 to out-of-gamut color 675. Hence, in this case, the color transformation 670 leads to a different boundary color 680 associated with out-of-gamut color 610, e.g. via mapping 685. As such, even though the same color transformation is applied in FIGS. 6A and 6B, a device would output different color sets for the same three out-of-gamut colors, e.g. when the color transformation is applied after the gamut mapping, colors 630 and 640, as transformed, are output by the device and when the color transformation is applied before the gamut mapping colors 630, 640 and 680 are output by the device.

FIGS. 6A and 6B, as well as other cases described herein, show that before gamut mapping, an available gamut may be larger than after the gamut mapping. As such, color transformations in regions of the gamut that are modified in the gamut mapping, e.g. that are collapsed to a new gamut boundary, may or may not work as expected. On the other hand, color transformations that are applied after gamut-mapping, e.g. on a device side of a pipeline operation, may not be collapsed in the gamut mapping. To use actual colors as an example, a case may be considered where a color transformation converts a set of bluish-green colors to a grass-green color. In this case, colors 610 and 615 may respectively comprise bluish-green colors and grass-green colors. If the color transformation is applied after gamut mapping, both the original bluish-green and grass green colors 610, 615 may be mapped in a common way to a common grass-green on the gamut boundary and then transformed in a predictable manner, as shown in FIG. 6A. However, if the color transformation is applied before gamut mapping, the bluish-green and grass green colors 610, 615 may have different within gamut colors and introduce unpredictable results. Applying a color transformation, such as a color shift in a particular direction, may preserve a relationship between colors if performed after gamut mapping, while applying the color transformation before gamut mapping may change the relationship before any collapse applied in gamut mapping.

It should be noted that forward color transformations as described herein may be converted to inverse color transformations and vice versa. For instance, expanding chroma in a forward color transformation may enable the complete transformation to render colors as more vivid. However, this forward color transformation may also be applied as an inverse color transformation by compressing the chroma of the second color space, which creates a similar effect in the complete transformation. In both case, an overall colorfulness mapping goes from a larger gamut to a smaller one, either by inflating the former or by shrinking the later. Color transformations may be applied as forward or inverse color transformations depending on desired color configurations, e.g. it may be desired to preserve a relationship between colors as described below.

Certain examples described herein allow for predictability of color adjustments. They allow for adjustments to be applied before gamut mapping in two directions. They allow easier configuration of a color processing pipeline to generate a desired “look and feel” of a rendered color image. They also provide better color quality as color adjustments can be applied in a controlled manner. Certain examples allow a color profile or device link profile to be generated, for both ICC-compliant systems and proprietary systems.

At least some aspects of the examples described herein with reference to the drawings may be implemented using computer processes operating in processing systems or processors, e.g. as described with reference to FIGS. 1 and 5. These aspects may also be extended to computer programs, particularly computer programs on or in a carrier, adapted for putting the aspects into practice. The program may be in the form of non-transitory source code, object code, a code intermediate source and object code such as in partially compiled form, or in any other non-transitory form suitable for use in the implementation of processes described herein. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

Similarly, it will be understood that a processor may in practice be provided by a single chip or integrated circuit or plural chips or integrated circuits, optionally provided as a chipset, an application-specific integrated circuit (ASIC), field-programmable gate array (FPGA), etc. For example, this may apply to all or part of a controller or other printer control circuitry. The processor may be an embedded processor of a rendering device such as a printer or monitor.

The preceding description has been presented only to illustrate and describe examples of the principles described. This description is not intended to be exhaustive or to limit these principles to any precise form disclosed. Features of individual examples may be combined in different configurations, including those not explicitly set out herein. Many modifications and variations are possible in light of the above teaching.

What is claimed is:

1. A method comprising:
generating a color mapping between a source color gamut within a source color space and a target color gamut within a target color space, at least one of the source and target color spaces comprising a device-dependent color space and at least one of the source and target color gamuts being set based on properties of a rendering device,
wherein generating a color mapping further comprises:
defining a sequence of forward color transformations that transform the source color gamut;
defining a sequence of inverse color transformations that transform the target color gamut; and
applying a gamut mapping between the output of the forward color transformations and the output of the inverse color transformations,
wherein the color mapping is usable by a computing device to map between the source and target color spaces.

2. The method of claim 1, wherein generating the color data comprises:
generating a multidimensional look-up table representative of the mapping; and
encoding the multidimensional look-up table in a color profile for use by a computing device to map the first color space to the second color space.

3. The method of claim 2, comprising:
applying smoothing to values within the multidimensional look-up table.

4. The method of claim 1, wherein:
the first color space comprises a device-independent color space and the second color space comprises the device-dependent color space;
the first color space comprises the device-dependent color space and the second color space comprises a device-independent color space; or
the first color space comprises a device-dependent color space for a first device and the second color space comprises a device-dependent color space for a second device.

5. The method of claim 1, wherein the first color space comprises a profile connection space and the second color space comprises a color space for the rendering device, the color mapping data being useable by a computing device to process color image data for rendering on the rendering device.

6. The method of claim 1, wherein the sequence of forward color transformations comprises an ordered sequence of a plurality of color transformations selected from the set of:
adjusting the first color space based on a reference media;
adjusting the first color space based on a defined tone curve;
adjusting the chroma characteristics of the first color space;
adjusting the saturation characteristics of the first color space; and
applying black point compensation.

7. The method of claim 1, wherein the second color space is associated with the rendering device and the sequence of inverse color transformations comprises an ordered sequence of a plurality of color transformations selected from the set of:
applying a correction for gray axis mapping;
constraining the dimensionality of the second color space; and
adjusting a modeling of a device response for the rendering device.

8. An apparatus for generating color mapping data comprising:
a processor;
a storage medium storing:
computer program code representing a library of color transformation functions, each color transformation function having a set of parameters and operating on input color data to generate output color data;
computer program code representing a gamut mapping function, the gamut mapping function mapping a source color gamut to a target color gamut;
data defining a color gamut for a rendering device, the color gamut being set based on properties of the rendering device; and
computer program code that when executed causes the processor to:
receive a sequence of forward color transformations selected from the library of color transformation functions that is to be applied to transform a source color gamut defined within a source color space;
receive a sequence of inverse color transformations selected from the library of color transformation functions that is to be applied to transform a target color gamut defined within a target color space, wherein one of the source color gamut and the target color gamut comprises the color gamut for the rendering device;
provide the transformed source color gamut and the transformed target color gamut as inputs to the gamut mapping function; and
output color mapping data generated based on the received sequences and the gamut mapping function that maps color data from the source color space to the target color space.

9. The apparatus of claim 8, wherein the color mapping data comprises one of a color profile and a device-link profile to map color data for rendering on the rendering device.

10. The apparatus of claim 8, wherein the color mapping data is generated in the form of a look-up table by sampling data points in at least one of the source and target color spaces and applying the received sequences and the gamut mapping function to the sampled data points.

11. The apparatus of claim 8, wherein the rendering device comprises a two or three dimensional printer.

12. The apparatus of claim 8, wherein the target color space comprises one of a Red Green Blue (RGB) based color space and a Cyan Magenta Yellow and Black (CMYK) based color space.

13. The apparatus of claim 8, wherein the sequence of inverse color transformations is applied starting from the target color space, and wherein an output of a first inverse color transformation applied to a data point in the target color space is passed to an input of a second inverse color transformation for ordered pairs of first and second inverse color transformations in the sequence of inverse color transformations.

14. A non-transitory computer-readable storage medium storing instructions that, when executed by a processor, cause the processor to:
obtain a gamut mapping function applicable to a source color gamut defined within a source color space and a target color gamut defined within a target color space;
receive a sequence of forward color transformations selected from a library of color transformation functions that is to be applied to transform the source color gamut;
receive a sequence of inverse color transformations selected from the library of color transformation functions that is to be applied to transform the target color gamut, wherein one of the source color gamut and the target color gamut comprises a color gamut for a rendering device, the color gamut being set based on properties of the rendering device;
configure an output of the sequence of forward color transformations and an output of the sequence of inverse color transformations as modified inputs to the gamut mapping function; and
generate color mapping data for mapping from the source color space to the target color space based on an application of both sequences of color transformations and the configured gamut mapping function.

15. The medium of claim 14, wherein the source color space comprises a profile connection space and the target color space comprises a device color space for the rendering device, and the color mapping data comprises a color profile for the rendering device.
